(19) United States
(12) Patent Application Publication
(10) Pub. No.: US 2006/0010052 A1
(43) Pub. Date: Jan. 12, 2006

(54) Novel method and system for vehicle financing

(76) Inventor: Paul D. Willingham, Fresno, CA (US)

Correspondence Address: National IP Rights Center, LLC, Suite 400, 550 Township Line Road, Blue Bell, PA, 19422, US

(21) Appl. No.: 10/887,562

(22) Filed: Jul. 9, 2004

(51) Int. Cl. G06Q 40/00

(52) U.S. Cl. 705/35

(57) ABSTRACT

A method for financing a vehicle; establishing a purchase price for a vehicle; establishing a collateral investment vehicle; setting forth a payment plan over a pre-set period of time such that a portion of the payment goes toward the payment of the vehicle and a portion goes to a collateral investment plan.

### FIELD OF THE INVENTION

The present invention is directed to a novel method for financing vehicle ownership. In particular the present invention is directed to a system for financing vehicle ownership and building up cash value in a separate investment account which can be used to purchase future vehicles and other personal financial goals.

### BACKGROUND OF THE INVENTION

Each year millions of people buy new automobiles, trucks, RVs, motorcycles and other forms of transportation. At present, there are two popular forms of vehicle financing. The conventional form of financing is the so-called “chattel mortgage” in which the vehicle serves as the security for a term loan. Under a chattel mortgage, a financing institution, such as a bank, holds title to the vehicle and provides a loan with interest. As the loan is paid off, the purchaser acquires equity in the vehicle and at the time of pay off, acquires the title. The vehicle, once paid off and owned, can then be sold or traded to help finance the purchase of a new vehicle. Accordingly, at the end of the day, the purchaser has a depreciated asset which he must use to purchase a new vehicle.

Alternatively, vehicle leasing has become a popular option. In a lease arrangement, the customer essentially “rents” the vehicle for a pre-determined period of time. In essence, the customer pays a lease value roughly equal to the depreciation on the vehicle plus a surcharge in the form of interest and a profit for the sales agency. Monthly lease rates are in large measure based upon the residual value of the vehicle at the end of the lease. The more likely the vehicle is to retain its value, the lower the payment.

Leases can be open-ended or closed-ended. In an open-ended lease, the customer is given the ability to purchase the vehicle at the end of the lease.

With the demand for greater quality and the saturation of the North American market with European and Japanese cars, the demand for higher vehicle quality and vehicle performance has increased dramatically. Major vehicle manufacturers provide “bumper to bumper” warranties for their cars for sixty thousand (60,000) miles or more. New car prices have placed new car ownership beyond the reach of many people and/or have resulted in increased monthly payments over longer terms. Many conventional financial institutions such as banks have stopped making car loans, thus leaving the task to special entities created by the manufacturers such as GMAC, Toyota Motor Credit Corporation and Nissan Motor Acceptance Corporation.

While people “purchase” cars, in a real utilitarian sense, they are a necessity and ongoing cost of modern life. Unlike homes, cars only have a useful life of perhaps 5 to 7 years. Hence, while, the average person may own only a single home through out this or her life, whose value may actually double and triple, they may purchase 10 or more cars.

Both forms of conventional vehicle financing have their drawbacks. Chattel mortgages essentially provide ownership over a depreciating asset that ultimately will have little value at resale. Leases provide no ownership interest in the vehicle. In both cases, though, the cost is based upon a recognition that a vehicle, unlike a residential home, is a depreciating asset which may have to be repossessed and which may be damaged or even stolen. In order to entice sales, the major car companies have also created various products such as “0%” financing and the GM “Smart Lease.” There have been a number of patents directed to creative or alternative financing systems. U.S. Pat. No. 4,736,294 discloses data processing methods and apparatus for managing vehicle financing. The data processing system provides information to assist in granting a loan applicant credit, processes the loan, and determinates at the time of making the loan a residual value of the vehicle at a predetermined option date.

U.S. Pat. No. 6,564,190 discloses a rule-based decision process which formulates an investment strategy in terms of short term debt, long term debt, short term equity, and/or long term equity for a variety of property types and geographic markets. The first phase of the method achieves a visual representation of the condition of each of a selected territory's major markets, showing market direction and volatility determined on the basis of commercially available market research data which has been adjusted by the investing entity in light of actual local experience in the market. The second phase deals with the implications of the first phase results on four possible alternative investment types, namely, short term debt, long term debt, short term equity, and/or long term equity.

U.S. Pat. No. 6,321,212 discloses methods and systems for trading and investing in groups of demand-based adjustable-return contingent claims, and for establishing markets and exchanges for such claims. The advantages of the present invention, as applied to the derivative securities and similar financial markets, include increased liquidity, reduced credit risk, improved information aggregation, increased price transparency, reduced settlement or clearing costs, reduced hedging costs, reduced model risk, reduced event risk, increased liquidity incentives, improved self-consistency, reduced influence by market makers, and increased ability to generate and replicate arbitrary payout distributions, In addition to the trading of derivative securities, the present invention also facilitates the trading of other financial-related contingent claims; non-financial-related contingent claims such as energy, commodity, and weather derivatives; traditional insurance and reinsurance contracts; and contingent claims relating to events which have generally not been readily insurable or hedgeable such as corporate earnings announcements, future semiconductor demand, and changes in technology.

U.S. patent application Ser. No. 2003/0074296 discloses a method and system to evaluate residual value of leased products, comprising a learning phase and an application phase. Each phase has two steps. The first consists in analyzing lease or product main parameter while the second uses other lease conditions or product characteristics. Analysis is based on a grid wherein several specific points are determined during the learning phase. An extrapolation of these points according to the parameters during the application phase gives a first approximation of residual value, which is adjusted using lease conditions or product characteristics. During the learning phase, the system determines the relevant lease conditions or product characteristics and the associated corrections used during the application phase.

U.S. patent application Ser. No. 2002/0065753 discloses a financing enterprise cooperatively owned by at least three originators of financial instruments, no single originator owning 50% or more of the financing enterprise. The originators and financing enterprise cooperatively specify underwriting standards for financial instruments. The financing enterprise purchases financial instruments from the originators and aggregates them into pools for resale in the financial markets. No single originator has 50% or more representation in any pool. The financing enterprise only purchases financial instruments conforming to the underwriting standards, though the originators are free to originate other financial instruments, and financing enterprise is not bound to purchase all financial instruments tendered by the originators. The financing enterprise may offer the financial instruments in the form of structured securities backed or secured by the financial instruments.

WIPO Patent Application No. 02/12984 discloses a method and apparatus for implementing a combined investment. Financing is obtaining by collateralizing a first investment representing ownership interests of a plurality of independent investors. The financing is used to acquire a second investment. At least a portion of any returns on the second investment is applied to the benefit of the independent investors. In this manner, investors effectively get the benefit of two investments for the cost of one. By differentiating the asset classes of the two investments, greater diversification is provided. Through pooling of investor capital and/or fractional share ownership, even greater diversification and better investment opportunities may be achieved. By selecting complementary investments, e.g. growth oriented securities and income-producing real estate, a beneficial synergistic effect may be obtained when the investments are cooperatively managed, e.g. by cross-utilizing returns, with a common objective of providing enhanced returns.

While there have been a number of types of creative financial instruments and methods, none have been directed to new methods of vehicle financing which combine an investment option with vehicle ownership. Heretofore, there has been no financial system which takes into account the lifetime reality of motor vehicle ownership, which correctly views it as a recurring and ongoing lifetime expense, and which provides a vision of vehicle ownership and turnover compatible with the real world experience of most people.

It would be desirable to provide a system whereby car and vehicle purchasers could pay for a vehicle over a longer term, with a portion of the money going into an investment account for future purchases and fund other future personal financial needs.

It is an object of the present invention to provide a system and method for facilitating the purchase of new cars and vehicles.

It is a further object of the present invention to provide a system which accounts for the vehicle purchasing patterns of people over the long run.

It is a further object of the present invention to provide a system which enables a car purchaser to establish a separate investment account to assist in the purchase of future vehicles.

It is a further object of the present invention to provide a system in which a collateral/investment fund is built up to back the purchase of the vehicle.

These and other objects of the invention will become apparent from the detailed description which follows.

### SUMMARY OF THE INVENTION

The present invention is directed to a system wherein a vehicle can be purchased such that the loan term is longer and part of the money goes into an investment fund to be used for future purchases.

In a preferred embodiment, the invention comprises a method for financing a vehicle comprising establishing a purchase price for a vehicle; establishing a loan price to purchase the vehicle; establishing a collateral investment account; setting forth a payment plan over a pre-set period of time such that a portion of the payment goes toward the payment of the vehicle and a portion goes to a collateral investment which acts as security for the vehicle and as an investment.

In a further embodiment, the invention is a method for financing a vehicle; establishing a purchase price for a vehicle; establishing a loan price to purchase the vehicle; establishing a collateral investment vehicle; setting forth a payment plan over a pre-set period of time such that a portion of the payment goes toward the payment of the vehicle and a portion goes to a collateral investment which acts as security for the vehicle.

In still a further embodiment, the invention is a method for financing a vehicle; comprising the steps of establishing a purchase price for a vehicle; establishing a loan price to purchase the vehicle; establishing a collateral investment vehicle; setting forth a payment plan over a pre-set period of time such that a portion of the payment goes toward the payment of the vehicle and a portion goes to a collateral investment which acts as security for the vehicle.

### BRIEF DESCRIPTION OF THE FIGURES

FIG. 1 is a block diagram of the operation of the present invention.

FIG. 2 is a flow chart which illustrates the operational flow of the present invention.

FIG. 3 is a block diagram of a more comprehensive embodiment of the invention.

Appendix A is a spreadsheet illustrating the operation of the present invention.

### DETAILED DESCRIPTION OF THE PREFERRED EMBODIMENT

The present invention is described with reference to the enclosed Figures, wherein the same numbers are used where applicable. The invention is broadly directed to a novel method and system for financing motor vehicle purchase. For the purpose of this disclosure, the term “vehicle” refers to an automobile, SUV, truck or van, or similar transportation. The term collateral/investment fund relates to an investment pool which is used to build equity and to finance future vehicle purchases. The invention improves over existing methods by providing such an auxiliary investment feature which builds collateral with which to finance the purchase of the vehicle, and which can roll over for future purchases.

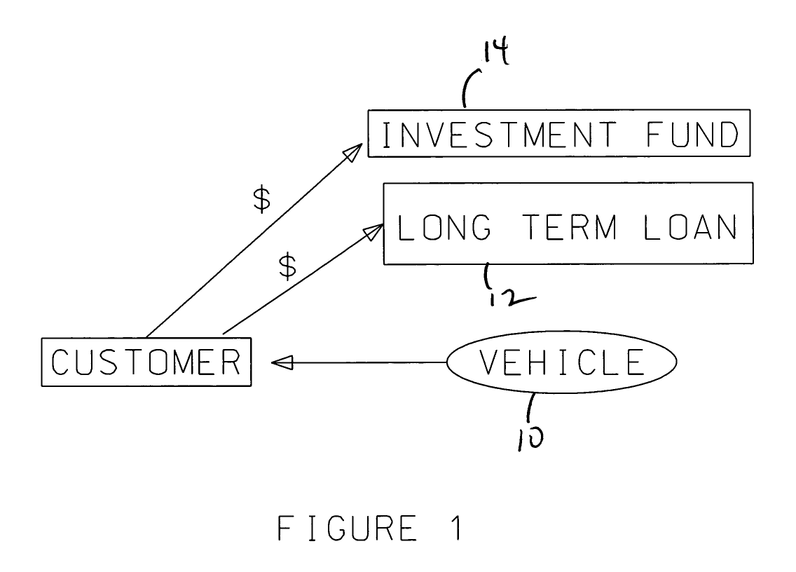

FIG. 1 illustrates the method of the invention in a preferred embodiment. In this embodiment, a car is purchased 10 such that a portion of the payment goes to a long term loan 12 and a collateral or investment fund 14 is established at then time of vehicle purchase or before purchase. For example, the fund can be established at the time of a child's birth or at an event such as a First Communion, Graduation or Bar/Bat Mitzvah.

At the time the vehicle is purchased, the vehicle is then subject to a long term loan 12 which may be set at a fixed or variable interest rate. The term of the loan will typically be set for a period far in excess of that normally associated with vehicle loans, e.g., fifteen, eighteen or even twenty years. In conjunction with the loan, the collateral/investment fund 14 is set up such that a portion of the monthly payment goes to the loan principal and interest on the loan and a portion goes to the investment fund. Over time, the payment of the vehicle continues building equity in the vehicle. In addition, simultaneously, the size of the collateral fund is increased. The fund may be placed in investment funds which grow over time. The fund may be under the control of the customer.

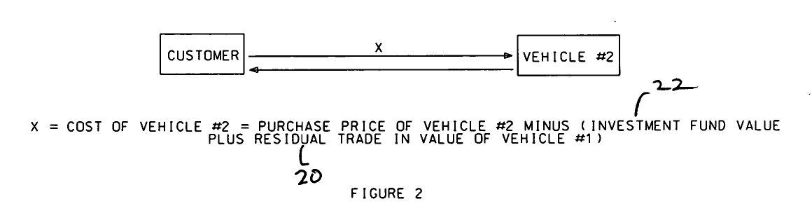

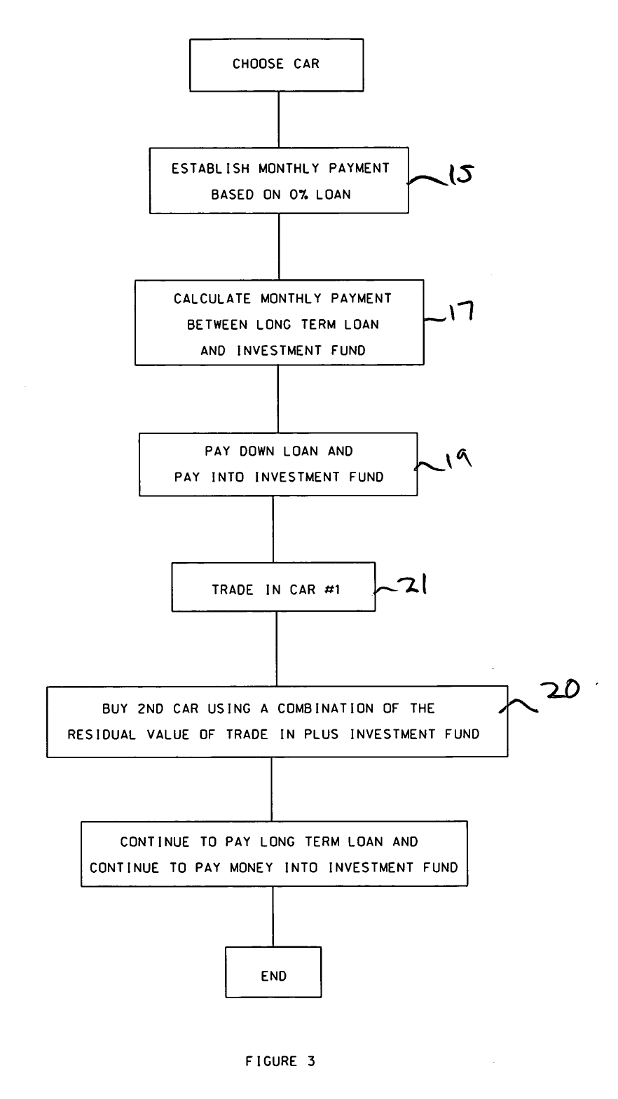

As shown in FIGS. 2 and 3, as the size of the investment instrument increases and grows, the purchasing power of the customer increases. The vehicle is priced based upon a zero percent (0%) loan 15. A monthly payment is correlated between a long term (e.g. 15 years) loan and an investment fund 17. The loan is paid down and the investment fund increases 19. At the time of trade in, the second car is purchased using the value of the investment fund and the first car's residual value. When a second car is purchased, the residual value of the vehicle 20 can be used with the proceeds of the fund 22 to purchase the second vehicle. One of the unique features of the loan is that it is for a substantially longer period of time than that of conventional car loans, perhaps up to fifteen (15) years. The extended period drops the minimum monthly loan payment and provides additional money to invest.

In one embodiment, the system provides an option whereby in times of distress, the collateral/investment can be used to pay the car loan. In addition, in the event of a major repair, the collateral fund may be usable for the purchase of tires, oil changes and the like.

The loan may be readjusted and balanced over a period of time (e.g. every 3 or 5 years). At the time the first vehicle is paid off, the fund may revolve again. The lien on the vehicle may be released. When the vehicle is paid off, the fund can be reissued as collateral on a new vehicle or as security on the outstanding loan amount.

The present invention facilitates a scenario whereby children can have money placed in an investment fund for a future car. Parents, friends and family can make gift bequests and establish a collateral fund at the time the child achieves driving age (e.g. 16 or 17).

A more detailed embodiment of the present invention is now described with reference to the attached spread sheet shown in Appendix A. As shown, the invention is based on the premise that a longer loan term will permit a car to be purchased at a longer period. The initial step is for the customer to identify a car he or she wishes to purchase and determine monthly payment he or she is able to pay. A loan rate is then set and an amount is then calculated so that a portion of the amount goes to the loan and some goes to an investment vehicle. In the example above, it is assumed that the purchaser desires to purchase a vehicle worth $42,000. The vehicle is provide at a discount at $39000. A payment at zero percent (0%) is then calculated at the list price of 42,000. This value is $700.00 per month over sixty (60) months.

A monthly payment rate is set based upon fifteen (15) year payments at a percentage rate (e.g. 8%). This payment is $372.70. The difference ($100 to $372.70) or $327.30 is then placed in an investment earning nine percent (9%) (this percentage may vary). This investment serves as further collateral for the loan.

After 5 years, the customer has $24,871.14 in his account. He also has a vehicle which has a 60% residual value or $25,200. The customer then has $50,071.14 ($24,871.40 plus $25,200) of cash and equity to buy a new $39,000 vehicle. This will leave $11,071.14 to reinvest at 9%. The customer must continue to make $372.70 payments on the fifteen year loan. The customer will continue to invest $327.30 At the end of ten years, the customer has an accumulated value of $42,205.01. With the residual value of the vehicle at $25,200, the customer's total equity in cash and residual vehicle value is $67,405.01.

The customer purchases a third $42,000 car (at $39,000); he has $28,405.01 to commence. He continues to pay off the rest of the loan and continues to invest $327.30. At the end of fifteen years, the loan is fully paid.

The client then has substantial cash in the collateral/investment account to buy a new car without any further loan. The customer can cash out entirely and close the account. As seen in the Appendix, at the end of 20 years, the account has a value of over $138,000.

The invention thus provides a system where a customer, after the purchase of three or four cars, has built up a permanent interest bearing equity account which he or she can use to purchase vehicles for the rest of his/her life. It is to be appreciated that the values set forth in the Appendix can be altered. Moreover, they can be set such that a customer can calculate the amount of money to be invested so that a $42,000.00 could be purchased for the rest of his or her life, strictly based upon the interest and principal.

The client could use the combination of the accumulated collateral and the residual value of the original vehicle to purchase a new vehicle. This may allow for a discount in price for a cash purchase. The client would then continue on with the original plan, making payments into the plan as if he has borrowed the full purchase price of the new vehicle.

As noted, the system restructures the loan to include the difference between the cash purchase price of the new vehicle and the residual value of the original vehicle. The loan would extend out another five years and the client would continue to pay as if he had received a full purchase price loan on the new vehicle.

The present invention has been described with reference to the enclosed Figures. It is to be appreciated that the teachings of the present invention are applicable to any large, recurring vehicle purchase for both business or personal use. It is to be appreciated that other embodiments fulfill the spirit and scope of the invention and that the true nature and object of the present invention will become apparent from the claims which follow.

1. A method for financing a vehicle;
establishing a purchase price for a vehicle;
establishing a loan amount to purchase the vehicle;
establishing a collateral investment fund;
setting forth a payment plan over a pre-set period of time such that a portion of the payment goes toward the principle payment of the vehicle loan and a portion goes to the collateral investment which may act as security for the vehicle and which increases over time.

2. The method of claim 1 wherein the payment further goes toward interest on the loan.

3. The method of claim 1 wherein the interest rate of the loan is adjustable at pre-selected intervals.

4. The method of claim 1 wherein the collateral may be used to make a car payment.

5. A method for financing a vehicle;
establishing a purchase price for a vehicle;
establishing a loan price to purchase the vehicle;
establishing a collateral investment vehicle;
setting forth a payment plan over a pre-set period of time such that a portion of the payment goes toward the payment of the vehicle and a portion goes to a collateral investment which acts as security for the vehicle.

6. A method for financing a vehicle;
establishing a purchase price for a vehicle;
establishing a loan amount to purchase the vehicle;
establishing a collateral investment vehicle;
setting forth a payment plan over a pre-set period of time such that a portion of the payment goes toward the payment of the vehicle and a portion goes to a collateral investment which may act as security for the vehicle and which can be used for repairing the vehicle or making loan payments.
